(19) United States
(12) Patent Application Publication
(10) Pub. No.: US 2011/0010370 A1
(43) Pub. Date: Jan. 13, 2011

(54) Method of Generating a Publication

(76) Inventor: Rodger Cosgrove, Riverside, CA (US)

Correspondence Address: Kenton Abel, 3259 Cabo Blanco Dr., Hacienda Heights, CA, 91745, US

(21) Appl. No.: 12/834,861

(22) Filed: Jul. 12, 2010

Related U.S. Application Data
(60) Provisional application No. 61/224,690, filed on Jul. 10, 2009.

(51) Int. Cl. G06F 17/30

(52) U.S. Cl. 707/748; 707/E17.005

(57) ABSTRACT

The present invention relates to generating a plurality of publications for a plurality of recipients.

This application claims priority to U.S. Ser. No. 61/224,690, titled “Method of Publishing Newspapers and Other Periodicals,” filed Jul. 10, 2010.

### BACKGROUND

The present invention is in the field of publishing, especially of periodicals such as newspapers and magazines.

Since the first periodicals were published with movable type in the early 17^{th} Century they have been until very recently printed in one or a limited number of static versions. That is, the content, including advertising, has been the same for every unit in the print run. Due to the high cost of changing any image or text, the model of providing the same content for every recipient was the only practical way to print periodicals conventionally. Thus, each recipient would receive identical content regardless of its relevance or value to the recipient or to any sponsoring advertisers.

### SUMMARY OF THE INVENTION

In one embodiment, the present invention provides method of generating a printed publication comprising a first database set comprising a plurality of recipients, a second database set comprising a plurality of publication content, and for each of the recipients, generating a custom subset of content from the plurality of publication content based upon a dynamic scoring function to match content with recipient, wherein at least one inclusion criteria is set for each publication content. The custom subset of content for each of the recipients is printed to generate the printed publication.

### BRIEF DESCRIPTION OF THE FIGURES

FIG. 1 shows a diagram of one embodiment of the present invention.

FIG. 2 shows a diagram of one embodiment of the present invention.

FIG. 3 shows a diagram of one embodiment of the present invention.

FIG. 4 shows a diagram of one embodiment of the present invention.

FIG. 5 shows a diagram of one embodiment of the present invention.

### DESCRIPTION

Recent technological developments in variable digital printing (VDP) now make it possible to print a newspaper or magazine with variable content. The first example of this, and possibly the first example of “XVDP”™ or eXtreme Variable Digital Printing where at least part of the composition includes graphic or text data unique to a single recipient and therefore not practically cacheable as pre-rasterized data in computer memory, was produced by the inventor of the present invention for Reason® magazine in 2004 consisting of over 40,000 unique outside and inside covers. More recently, in 2009, Time Warner® produced Mine Magazine, a VDP magazine with variable editorial content as selected by recipients and advertisements from a single advertiser wherein the text of the advertisements was customized with the name of each recipient.

However, none of the prior art VDP magazines allowed for the advertisements to be unique to each recipient. Also, none of the prior art VDP magazines allowed for the sponsoring advertiser to select the recipients who would receive an advertisement as indicated by their ranking within a continuous range of values reflected by a scoring model as opposed to a simpler true vs. false qualification within a conventional segmentation scheme involving one or more variable attributes.

Although the cost to produce a publication of a certain quantity or greater is currently less for conventional printing than digital and VDP processes, conventional printing can result in higher costs to present a certain amount of information of interest or relevance to the recipient because a large proportion of the publication may be content that is not of interest or relevance to that recipient. This principle put printed periodicals at a disadvantage compared to the internet because the internet is able to easily and inexpensively tailor the presentation of content to the user.

The periodical has been losing marketing dollars to the internet because of the internet's ability to dynamically present data, essentially untethered to space and time, and because of its interactive functionality. However, this very disassociation from space and time can sometimes limit the internet's utility to human recipients who, like the paper periodical, exist in real space and time.

The present invention bridges these two worlds by providing “digitally enabled paper” which is both composed and printed digitally and therefore can also include “Personalized URL's” (PURL's) which are individually customized micro-landing-sites on the internet, bar codes, or other features that can link printed data to the internet. The present invention thus enables interactivity between and among a particular recipient, other recipients, advertisers or potential advertisers and their agents, the publisher(s), content providers, potential content providers, and other parties including but not limited to individuals or government agencies.

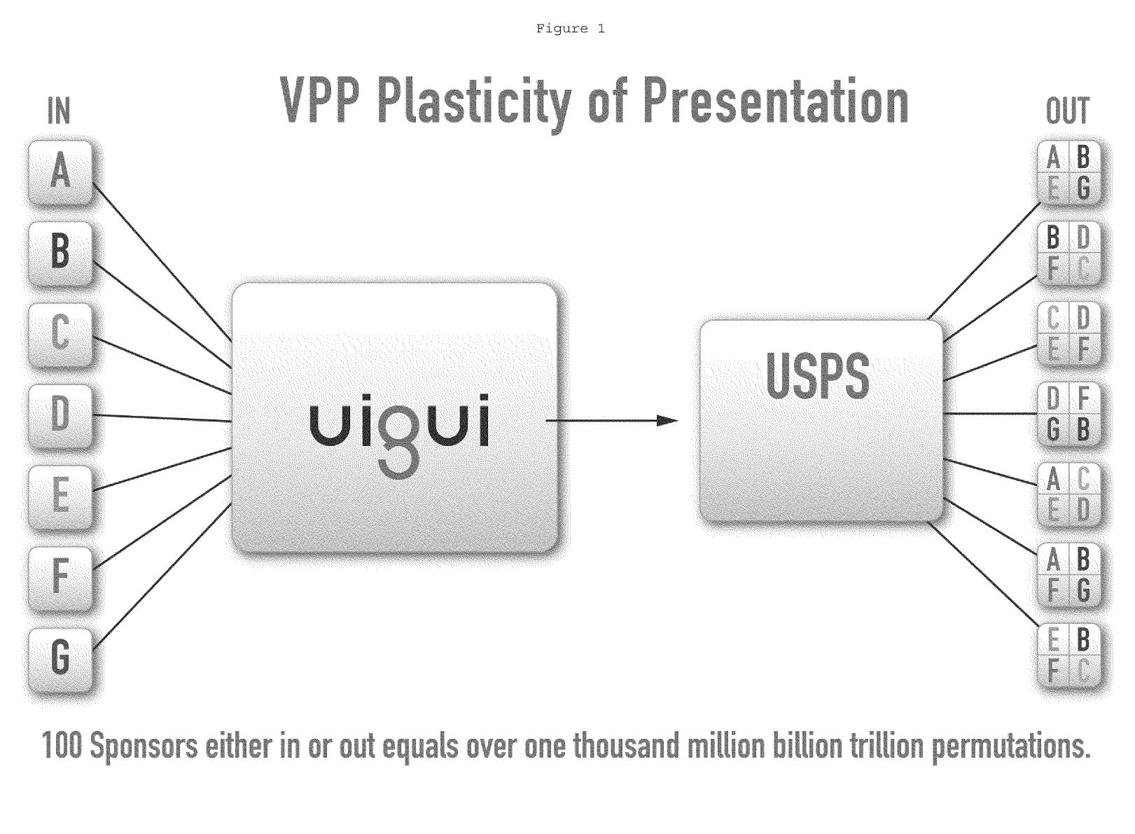

In reference to the figure, FIG. 1, “VPP Plasticity of Presentation” illustrates the power of Variable Participation Publishing as a platform for customized presentation of graphic communications to present an essentially unlimited number of permutations of available data to each subscriber. In this diagram, merely 100 advertisers choosing to either present or not to a given prospect creates an astronomical number of possible combinations of information “objects.”

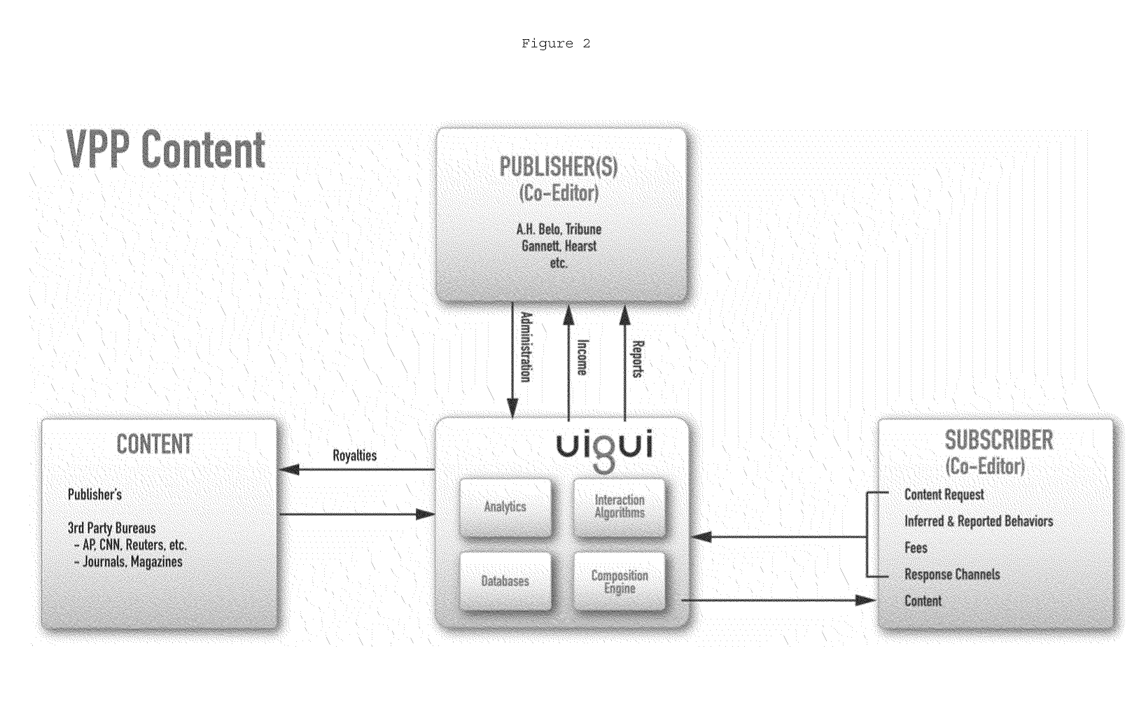

FIG. 2, “VPP Content,” illustrates fundamental relationships among the publisher(s), content providers, and the subscriber. The box labeled “UIGUI” is the principal data-media integration software platform that maintains and executes the business process management protocols to deliver custom defined content to the subscriber while collecting fees and/or information in consideration of that content for the publisher who will pay the provider through the UIGUI engine. UIGUI provides the artificial intelligence and rules system to integrate analytics, databases, inter-action algorithms among the subscribers, publisher and sponsors.

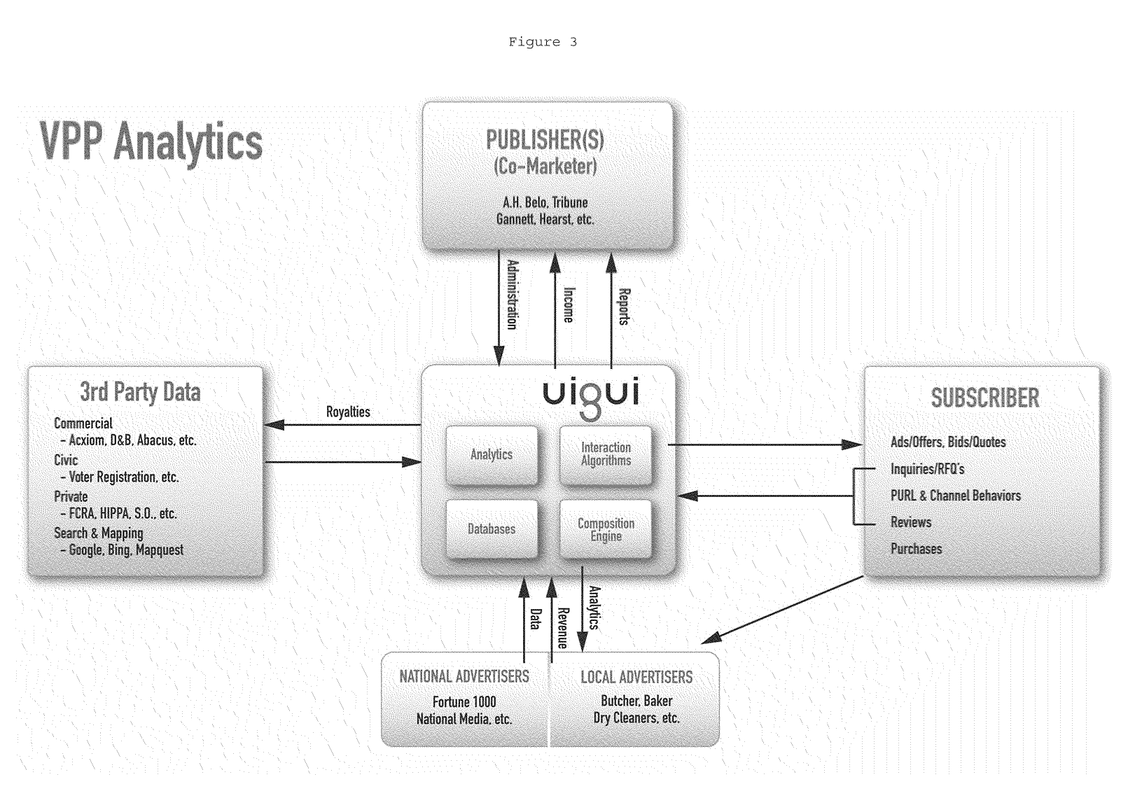

FIG. 3, “VPP Analytics,” shows how the publisher assumes the role of “Co-Marketer” with the advertisers-sponsors. 3rd party data vendors provide information to leverage the targeting efforts of the advertisers-sponsors in consideration of royalties received through the UIGUI engine.

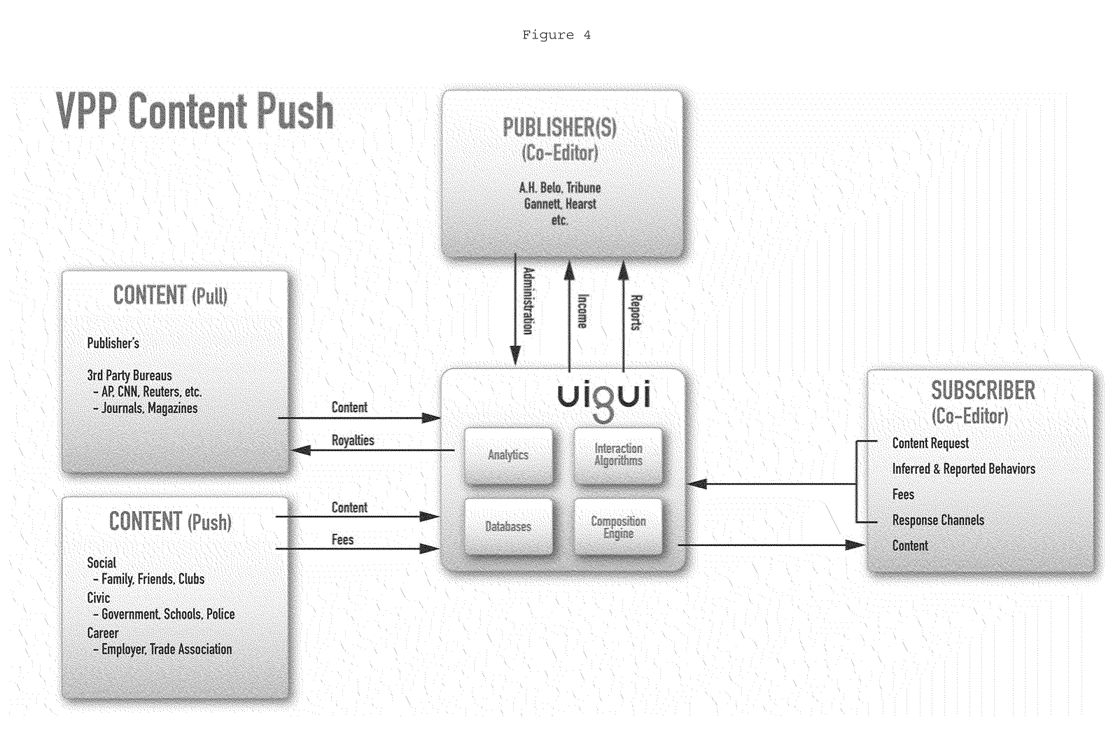

FIG. 4, “VPP Content Push,” shows how content demanded, i.e., “pulled down” by the subscriber is paid for by the subscriber through fees or the submission of information. Conversely, other entities, whether individual or collective, may pay to “push out” data to a set of one or more individuals in exchange for royalty payments.

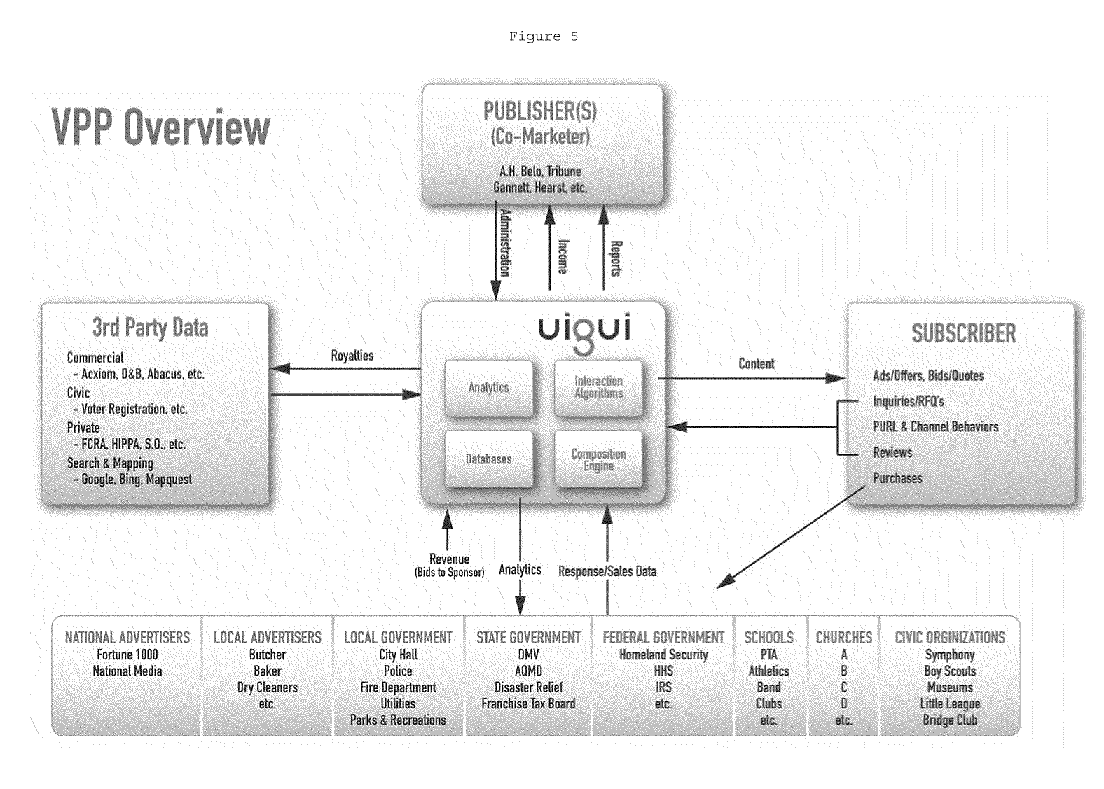

FIG. 5, “VPP Overview,” shows a high-level view of the principal parties involved in VPP production. This illustrates the diverse nature of the sponsoring and/or advertising entities that drive VPP applications.

The physically printed VDP periodical on paper also enjoys several significant advantages over the internet. The first advantage of printed paper over the internet is that paper can be addressed to households where the sender knows, or has better information about, who and where the recipient really is. The internet is a “pull” medium where the user pulls down data on demand whereas the periodical is a “push” medium where the publisher pushes content out to the recipient. Currently, traditional postal delivery of mail is the only practical way to reach anybody or everybody or any set in between. Databases of conventional names and postal addresses have by far the greatest depth and breadth of relevant, predictive data available to append among all media options. No other medium can make those claims.

A second advantage of paper is that graphic data is presented in much higher densities than than on a video screen. That is, the internet typically presents text and graphics at 72 dots per inch while digital presses typically offer dot densities between 200 and 600 dots per inch and higher. Images are clearer, colors are truer, and the reader experience is more gratifying.

A third advantage is that a paper periodical is currently more portable than the internet, not requiring a sophisticated electronic advice.

A fourth advantage of a paper periodical over the internet is that it can be targeted geographically much more effectively and precisely than the internet, as small as a single physical delivery point. Since each advertiser can choose each recipient, it is possible to limit a presentation to any geography no matter how small.

A fifth advantage of a paper periodical over the internet is its physical durability. Paper doesn't turn off, freeze up or get corrupted. A paper periodical can be targeted more accurately to sets of individuals according to demographics, credit data, property data, other financial data, self reported behaviors, and other criteria that are normally associated with individuals and their home or office addresses.

Paper periodicals are typically made from renewable, farmable resources, are bio-degradable, recyclable and non-toxic.

The present invention solves the deficiencies of both traditional and recent VDP publications because it entails a new business model that essentially makes the publisher a data driven “market maker” among the recipients, content providers, advertisers and other parties and agencies in unique and novel ways. The result is a set of singular units where the content for each unit is determined by business rules that seek to maximize the economic utility of each unit by balancing marketplace participants' bids and asks according to the value each participant places on its contributions or its potential for some relationship with one or more of the other participants. Participation, if any, in the publishing process is voluntary and variable for each participant.

In another aspect, the present invention provides that each printed unit essentially starts as a “blank slate” consisting of a fixed or variable number of pages. Each initially blank page has a certain area which is filled with typo-graphic composition according to business rules allocating space on the page(s) for any combination of editorial, advertising, or other content.

Therefore the publisher may compose and print any page if and only if the sum of recipient fees plus advertising sales exceeds the costs of content royalties, printing, distribution and all other costs of goods sold. The value proposition for each potential advertiser of any particular recipient could and would vary, from zero to high values. If no sponsor(s) would pay for some recipient's content nor pay sufficiently for advertising to subsidize the cost of the content, and if that recipient would not pay sufficient money or provide sufficiently valuable information as consideration for content, then the publisher could suspend or eliminate production for that recipient.

Therefore participation by any advertiser can be decided on a unit by unit basis according to each recipient's value. Likewise, each recipient may variably participate in the publishing process by providing more or less or no information to the publisher or advertiser-sponsor, or by requesting content, whether “free,” i.e., sponsored, or paid for by the recipient, or some combination of information and money. Additionally, the inherent plasticity of composition in VDP publishing means that both the amount of space for the advertisement and the presentation within that space can vary as well for each recipient.

The present invention is directed to a method of publishing newspapers and other periodicals. In one embodiment, the present invention includes a method of publishing newspapers and other periodicals with a) variable participation by content providers, recipients, advertisers and other parties, and/or b) variable presentation of editorial, advertising or other content, and/or, c) variable costs paid by advertisers for each recipient presented an advertisement, and/or d) variable costs paid by recipients as either money or consideration for self-reported information, consent to obtain other private information, or other such consideration, and/or e) variable frequency of publication from daily to weekly to monthly or any other time increment, fixed or variable, for each recipient.

The composition of each unit is the product of a computer algorithm that may include:
A. Value scores for each recipient to each advertiser, category of advertisers, or other sponsors.
B. Rules for what size, version, or VDP composition of an ad to present, if any.
C. Preferences, requests or orders of recipient for content.
D. Money contributions from recipient to pay for content.
E. Information contributions from recipient for benefit of advertiser(s) and/or publisher.
F. Availability and cost of content to publisher.

In contrast to the prior model of publishing where all of the presentation of information, i.e., static editorial content and advertising, is the result of business processes that balanced supply and demand for fixed space and distribution, the present invention means that the publisher essentially provides a one-to-one and one-to-many forum where demand is provided by both recipient and advertiser and supply is constrained by the costs of content from royalties to copyright owners, production, and distribution.

This new paradigm for organizing content and advertising to present to individual recipients means that any number of different algorithms or methodologies may be employed to define these singular presentations of graphic information without limitation. These algorithms and methodologies may be more or less engaged or weighted with respect to one or more of the variable participants and their contributions or influence, or it may, for example, simply execute the graphic layout from rules applied to objects provided by another program for rendering.

Although at least one periodical is already being developed to provide variable content according to recipients' declared individual preferences, and although advertisements have already been presented selectively to certain subsets defined by one or more categorical factors, the present invention differs from any prior variable digitally printed periodical by leveraging more value both from and for each and all of the variably participating parties involved. Variable Participation Publishing (VPP) creates a qualitatively different medium by opening the publishing process to both recipient and advertiser in novel and useful ways, especially the variability of various bids and asks within a fluid marketplace in order to publish an edition of one, near real time.

VPP may be categorized into two versions, a General Case and a Special Case. The General Case is simply the basic embodiment of that VDP periodical substantially described above. The Special Case additionally assumes universal distribution with a given community, especially at a larger regional, national or even international level.

A Special Case embodiment would entail delivering a copy of the publication to each and every household, much as a conventional “throw away” weekly newspaper is often distributed in a given town or metropolitan area. A universally distributed and individualized VPP periodical would enable new functions of great value for commerce, social media, education, and public safety to name a few. Below is a possible embodiment of VPP and notes on the advantages which accrue to various parties with different roles or interests in the composition, use and disposal processes natural to the publication's life cycle.

As stated earlier, the peculiar novelty and usefulness of the Variable Participation Publishing invention is primarily predicated on three new aspects of, and improvements to, prior VDP models: first, the ubiquity of the publication's distribution in the Special Case would produce an emergent phenomenon of a new type of social media not otherwise possible. Second, the orientation towards a publishing software platform that allows and encourages flexible roles and influences on the publication by all the involved and associated parties, according to those various parties' voluntary and variable interactions with the VPP data-media integrating graphic composition engine, according to rules established by the publisher(s). Third, the Aggregated Dynamic Scoring (ADS) model provides a powerful predictive functionality to magazine or newspaper advertising unlike anything previously offered due to its theoretically higher predictive power at far lower costs due to amortization of the development and maintenance costs of the scoring model by many participating sponsors and advertisers.

ADS enables unsophisticated users to harness the power of advanced data mining and analytical techniques typically available to larger, more expert marketing organizations. Analogous to the way creditor-recipients to credit reporting agencies all benefit by contributing and sharing data for analytical processes to improve direct response rates, sales conversion rates, or to mitigate risk, ADS lets smaller businesses target their best prospects from demand, risk or other scores derived from relatively large samples of records related to their specific market space and purposes. Larger sets of records correlated to certain observed behaviors, e, g., response or purchase, and appended with other predictive attributes from third party databases should yield better overall economic predictive value than simpler heuristic data segmentation schemes. The methods used by a skilled analyst may vary according to the goals of the model user, the quality of the data and other factors, but in general these processes would include, although not be limited to, methods such as simple profiling, i.e., using simple indices applied to readily definable sub-sets and derived from one or a few variables at the more elementary end of the analytical spectrum, to use of the more sophisticated Chi Squared Automatic Interaction Detector (CHAID), both techniques many business managers reasonably understand intuitively. A more sophisticated approach would be to use the much more “black box” method of so-called neural networks or genetic algorithms which are not intuitively comprehensible by the vast majority of users. The advantage of neural networks and genetic algorithms is they are readily incorporated into an automated, unattended process that may be continually updated and improved with fresh data. In some cases where economically warranted, the analyst would resort to the “gold standard” of predictive modeling, linear or logistic regression which often promises more causative explanatory power from the data. Unfortunately, regression mathematics require a more skilled practitioner than the black box methods which often rival and sometimes exceed the performance of regression models. Bayesian analytics may also be employed fruitfully in a largely automated record ranking process. Data contributions to ADS by any of the aggregated users can be achieved through automated processes such as reporting by a customer relationship management program, professional office or dealer management system software, or other programmed data channels. Or the information could be uploaded by more manual means, including submission of a spreadsheet, entry through an internet portal's user interface, or other more labor intensive data entry practices. The scoring model would need to be built for each vertical market targeted by the publisher on behalf of the advertiser for a particular vertical market. In this way the publisher would have a set of models for various applications, and these models should continue to get stronger as they are continually refined with more and more reported behaviors, i.e., outcomes from the marketing effort's offers, timing and other factors correlated with database attributes. The publisher can provide automated ways to capture and integrate response data, such as monitoring PURL sites or other response, inquiry or purchase channels, in order to make it easier and more reliable for the advertiser to report outcomes for each record targeted with a marketing offer.

In one embodiment, each major newspaper in a country would commit to universal distribution within its normal sphere of publication. In the United States this would often correspond to a city or county. The entire country could be covered by existing newspaper publishers using a common VPP software platform or on multiple software platforms communicating according to industry accepted protocols such as CIP4's Job Description Format (JDF) or Open Office or a similar standard and other appropriate business rules and processes. If the initial edition were distributed weekly as a “throw away,” the paper could immediately solicit participation from the recipient to become a real “recipient” and, if desired, a co-editor of his or her personal, individual publication. The recipient could go to the internet (or not) to interact with the publisher and possibly provide personal information, define content preferences, buy content, buy from or inquire of advertisers, or other actions to influence the presentation of content of interest and value to the recipient. The advantages that benefit each and all of the variably participating parties are shown in some of the examples below.

### EXAMPLE 1

Recipients—Content is tailored to each individual or household. John Jones can name his paper or magazine “The Jones Journal” or whatever pleases the Jones's. If they like mainstream sports, they can get all they want, or school sports, or exotic sports, it doesn't matter (if it's available). This can be true for any subject, the arts, opinion, world news, anything. If the Jones's are considered worth sponsoring by advertisers, they will be able to get sponsored content. They can buy additional content too. Or perhaps they turn off all advertising and pay for their own content entirely. Or selectively engage or disengage from sponsoring interests in order to build, with the publisher's help and the advertisers' support, the ideal weekly periodical. Personal preferences could include matters of individual usability too, such as type size depending on the recipient's vision. So the newspaper becomes the most interesting thing in the mail each week.

### EXAMPLE 2

Advertisers—Each advertiser can evaluate each recipient on a case by case basis to determine if an advertisement should be presented and if so, with what offer or message. The periodical assumes the advantages of targeted direct marketing. Many businesses do not have expertise in identifying their best individual prospects, which was never an issue in periodical advertising before anyway. But now those prospects can be identified according to various criteria supplied by the publisher or a third party. Multiple attributes for each household, obtainable from several national data vendors, can be incorporated into predictive scoring models to identify prospects with higher or lower propensities to behave, or purchase, a certain way. So a small local business could select recipient prospects from a scoring model that might include drive time, for example, as a predictive value and therefore, instead of having to purchase an expensive run of the press for a wastefully large area, this business could limit its presentation only to those few most qualified prospects in the immediate area.

### EXAMPLE 3

Publishers—By employing “aggregated dynamic scoring” publishers can build mathematically sophisticated scoring models to predict such qualities as demand, risk, or lifetime value, for example, for any number of business categories that have traditionally never been able to employ these methods. Besides usually not having the necessary skills to build a good predictive scoring model, small businesses typically do not have appropriate sample sizes, if any good data at all, to build a robust and reliable model. However, by aggregating the results of advertising offers from a plurality of participating merchants or other providers correlated to a database of recipient attributes, reliable up-to-date models can be built and maintained near real time. These models can be made available extremely cost-effectively to prospective advertisers. In fact, the publisher could know in advance within a certain margin of error how much response to expect from a certain offer made to a certain set of prospects, as predicted by the scoring model. This would enable the publisher to guarantee the results of the advertisement or even to sell it on a “per inquiry” basis. The advertiser cannot credibly cheat by understating results if they are far from predictions and, if that happens, the publisher can decline to make that contingent offer again to the errant advertiser. The publisher can offer, even safely guarantee, cost-effective advertising to a very large number of businesses that never or rarely bought advertising before VPP.

### EXAMPLE 4

Marketing Directors—Each coupon or advertisement published can be unique for each recipient.

Therefore any redemption can be linked using text or barcode or any readable data format to a particular household or individual to update that party's record in any prospecting or customer relationship management (CRM) database. In this way highly qualified prospects, say new homeowners who only comprise a fraction of 1% of the market in any given week, can be made a very generous offer not appropriate for the larger public. If redeemed, then different offers (or none again), perhaps reflecting the observed behavior of the respondent's purchase choice, size, cost, recency or other criteria, could be made in the future. This eliminates the “free loader” phenomenon where the same customers redeem the most generous coupons multiple times, yet it enables the merchant to be especially generous to the very few especially qualified prospects, a big advantage for the recipients.

### EXAMPLE 5

Social Media—If every household gets the newspaper then clubs, teachers, pastors, activists, friends—any group, organization or individual—can use that newspaper to deliver information to others associated with them. For example, a Cub Scout Den Mother could send picnic instructions just to the ten families with her scouts. A school could send announcements just to their students' homes. A church could send an announcement just to its member families, and it could send a different announcement for different ministries, one for families with children, one for seniors, and one for single adults. Families and friends could use it for personal and holiday greetings. It could be linked to other social media such as Facebook, LinkedIn or other sites or services.

### EXAMPLE 6

Public Safety—Public health, national security, and local law enforcement would all have an unprecedented communication channel with their communities, from a single home or business to a street, a neighborhood, a town, a region, state or continent. Planned traffic or utility service disruptions could be sent only to those affected far more economically than using single pieces of mail. Avenues of egress from crime scenes could be presented with information about the crime including pictures, time of incident, police contact information, etc. Emergency evacuation routes could be presented. Any number of special circumstances, warnings or instructions could be effectively and inexpensively presented to precisely targeted recipients. Environment—Universal VPP could drastically reduce the volume of conventional mail by enabling three traditional classes of mail in the United States—First Class used for personal correspondence and transactional messages such as invoices and statements, Periodical Class (formerly 2^{nd} Class) for magazines and newspapers, and Standard Class (formerly 3^{rd} Class) for advertising mail. A VPP publication could accommodate all three classes in one mailed unit if postal regulations allowed it. If most transactional and promotional mail were incorporated into the nation's households' weekly VPP publication, it would have tremendous impact on reducing the carbon footprint, pollution levels, energy costs, work hours and other logistical costs of conventional mail delivery. Pages containing transactional summaries linked by PURL's to online accounts could be three-hole drilled and have micro-perforated lines to allow easy page tear-out for inclusion in a ring binder that would keep all records organized and accessible. No more pile of different sizes of envelopes from multiple accounts.

### EXAMPLE 7

The marginal cost of manufacturing and mailing a single page within a VPP publication is less than 10% of the cost of posting a single First Class invoice or statement. Advertisers would enjoy the same benefits of vastly reduced manufacturing and postal costs if their offers could be selectively placed in a VPP publication.

### EXAMPLE 8

Civic Community—many socially beneficial institutions would benefit from VPP technology including park and recreation departments who could more effectively display schedules and events, chambers of commerce could more effectively welcome new residents and businesses, the registrar of voters could more effectively provide maps to the polling place for each precinct.

### EXAMPLE 9

Education—VPP can provide specialized articles or continuing education curricula more cost effectively than other channels because the information of value is printed “just in time” for one user at a time, on demand. The more specialized and arcane the field, the more information leverage is applied to the supply chain within a VDP environment.

### EXAMPLE 10

Flexible Convenience—Besides the benefit of having content and advertising matched to each recipient, the various categories of content and offers can be presented in ways most helpful to the recipient, similar to the way content is a arranged in sections by subject matter in a conventional paper, except now customized by the recipient. This could also include variable perforations around coupons or to facilitate tearing out certain pages, which could be achieved using a programmable laser perforator coordinated by instructions associated with the coupon or page.

### EXAMPLE 11

Dry Cleaner—very local area, clients mostly white/pink collar & uniformed vocations. Cannot afford conventional newspaper advertising because the distribution area is too large and unqualified. Direct mail is not cost effective because the individual unit cost is too high for a small mailing. VPP can target only nearby homes likely to house target prospects using the publisher's aggregated dynamic scoring (ADS) model that analyzes the results for a thousand dry cleaning shops. Coupons will be coded for individual response and sales conversion tracking Results will be updated into the ADS model for this vertical market. Also, weekly new homeowners are made a very generous offer to encourage a new customer relationship, but subsequent coupons sent to responders encourage loyalty and cross sales rather than steep discounts or giveaways.

### EXAMPLE 12

Fast Food—using the ADS model, coupons are presented to homes and businesses with individual bar codes. Responders are made new offers based on observed behavior after the initial and subsequent redemptions. The market area is very local, mostly blue collar and hourly wage workers.

### EXAMPLE 13

Fine Dining—using the ADS model, a fine dining establishment is likely to select for upper middle class households, professionals and executives, within a much bigger drive time area than the fast food restaurant. It is likely to offer local businesses a lunch or happy hour offer. Dinner may be focused more on upscale residents as prospects and on loyalty and retention efforts towards regular patrons. If a coupon is more awkward for this setting, then advertisements can use PURL's to link responders to the internet for offer redemption.

### EXAMPLE 14

Church—a church can send variable messages just to its constituents, and it can send different messages to different sub-categories such as seniors or youth groups. It can welcome new neighbors very cost-effectively. Hispanic named households are more likely to be Roman Catholic. Slavic named households are more likely to be Eastern Orthodox. And so forth. These and other attributes can be used to improve the quality and focus of communications within the church's membership and the larger community.

### EXAMPLE 15

Political—can target only registered voter households, can tailor the message to the affinities and hot buttons of different voters, can encourage voting by providing personalized maps to polling places.

### EXAMPLE 16

Hospital and Urgent Care and Veterinarian—all of these care givers should reach out to new neighbors but a large hospital has a much larger marketing area than an urgent care facility or veterinarian. The hospital may wish to market special optional procedures to more affluent prospects while the urgent care focuses on families with children and stresses convenience. A veterinarian's practice is usually fairly local but it may be able to target households known to have pets; if the vet is a specialist in an exotic animal, then advertising would be far less constrained by geography and better leveraged by knowledge of pet owners through specialized “vertical” lists or exotic pet club rosters.

### EXAMPLE 17

Car Dealer—different marquees have different prospects according to age, gender, ethnic group, income, vocation, credit, presence of children and many other predictive factors that could be included in an ADS model. If postal regulations changed to allow inclusion of First Class style pre-approved financial offers and if the Federal Trade Commission allowed such targeting, then credit bureau observed behavior data could be used to identify just those drivers with expiring purchase or lease contracts within the dealer's principal market area. Service reminders and cyclical communications could be offered within the newspaper and linked to the dealership by PURL. Any coupon or special offer could be linked to the customer through readable data such as bar code or text strings to locate the responder within a marketing database.

### EXAMPLE 18

Landscape Contractor—advertising would be restricted to property owners, perhaps of larger lots. New single family residence owners would be a desirable, targetable set of prospects compared to undesirable, avoidable condominium owners.

What is claimed:

1. A method of generating a printed publication comprising:
a) a first database set comprising a plurality of recipients;
b) a second database set comprising a plurality of publication content;
c) for each of said recipients, generating a custom subset of content from said plurality of publication content based upon a dynamic scoring function to match content with recipient;
d) printing said custom subset of content for each of said recipients to generate said printed publication;
wherein at least one inclusion criteria is set for each publication content.
